(19) United States
(12) Patent Application Publication
(10) Pub. No.: US 2012/0274561 A1
(43) Pub. Date: Nov. 1, 2012

(54) OPERATION CONTROL SYSTEM USING INFRARED RAYS AND METHOD THEREOF

(75) Inventor: HONG-BIN LEI, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/166,781

(22) Filed: Jun. 22, 2011

(30) Foreign Application Priority Data
Apr. 28, 2011 (CN) 201110108450.9

(51) Int. Cl. G09G 5/08

(52) U.S. Cl. 345/158

(57) ABSTRACT

An operation control method is provided. The method is applied on an operation control system. The system includes an operation device and an electronic device. The operation device includes an infrared emitter to emit infrared rays. The electronic device includes a display unit and infrared receivers. The infrared ray creates a light/heat spot on the display unit. Infrared receivers receive the infrared ray emitted by the infrared emitter. The infrared receiver receiving one infrared ray generates a corresponding signal. The method includes receiving the signal generated by the infrared receiver, determining which infrared receivers generated the signal to determine the light spot on the display unit, and controlling the electronic device to execute the corresponding function according to signals created by the light spot or spots striking the display unit.

### BACKGROUND

1. Technical Field

The present disclosure relates to operation control systems and methods thereof and, particularly, to an operation control system using infrared rays and a method thereof.

2. Description of Related Art

Infrared touch screens are widely applied in electronic devices. When the infrared touch screen is touched by an object, an infrared ray emitted by an infrared emitter is blocked, then an electronic device including the infrared touch screen determines which infrared receiver has not received the infrared ray, to determine which point has been touched, and executes a corresponding function. A shortcoming with the infrared touch screen is that physical contact must be made with the screen to cause the electronic device to execute a function, thus the user must be physically close to the screen, which may be harmful to the user's eyes if the electronic device is operated for a relatively long time.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of an operation control system in accordance with an exemplary embodiment.

FIG. 2 is a block diagram of the operation control system as FIG. 1 in accordance with an exemplary embodiment.

FIG. 3 is a flowchart of an operation control method in accordance with an exemplary embodiment.

### DETAILED DESCRIPTION

The embodiments of the present disclosure are now described in detail, with reference to the accompanying drawings.

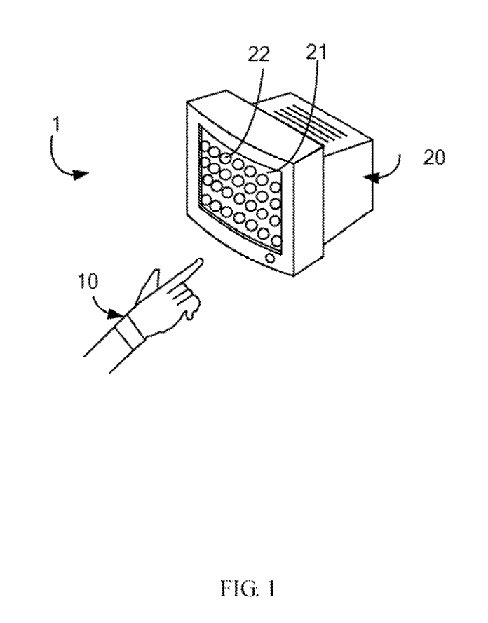

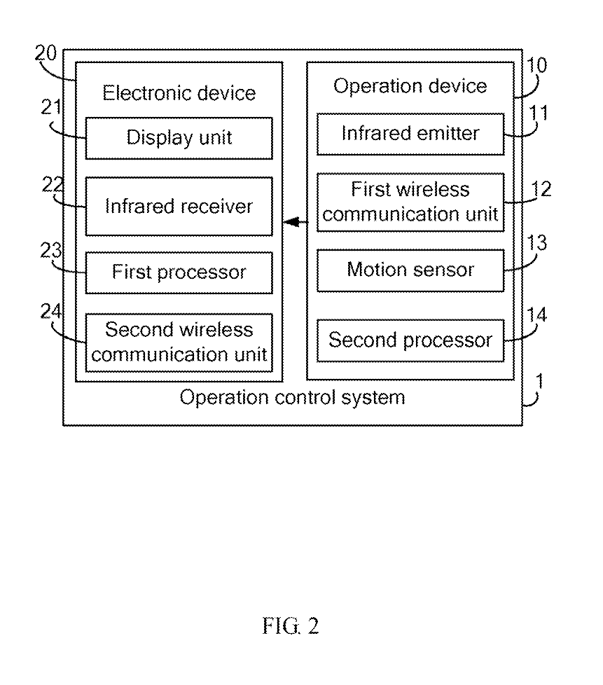

Referring to FIGS. 1-2, an operation control system 1 includes an operation device 10 and an electronic device 20. The operation device 10 may be worn on a wrist, on the head, or on a finger. In the embodiment, the operation device 10 is worn on a wrist.

The operation device 10 includes an infrared emitter 11. The electronic device 20 includes a display unit 21, a number of analog infrared receivers 22, and a first processor 23. The infrared receivers 22 are uniformly arranged in the display unit 21. In the embodiment, the infrared receivers 22 are arranged within a rectangle. Each infrared receiver 22 corresponds to a light spot on the screen, which can be energized when one infrared ray emitted from the infrared emitter 11 strikes it.

The infrared emitter 11 emits infrared rays from the operation device 10, the electronic device 20 must be located within the emitting range of the infrared emitter 11. When one infrared ray reaches the display unit 21, the particular infrared receiver 22 which corresponds to the light spot on the display unit 21 receives the infrared ray and generates a signal. For simplicity, hereinafter, the particular light spot activated or energized by the infrared ray is named as the touched spot.

The first processor 23 is electrically connected to the infrared receivers 22 to receive signals from the infrared receivers 22, and may determine the location of the infrared receiver 22 which generated the signal, to determine the touched spot on the display unit 21. The first processor 23 controls the electronic device 20 to execute a function based on signals from the first and subsequent touched spots.

In the embodiment, the operation device 10 further includes a first wireless communication unit 12, a motion sensor 13, and a second processor 14. The electronic device 20 further includes a second wireless communication unit 24.

The motion sensor 13 is to sense the acceleration and direction of movement(s) of the operation device 10.

In another embodiment, the direction of movement of the operation device 10 is established according to the strength of the signals from one or more of the infrared receiver 22. When the first processor 23 determines that the signals are gradually becoming stronger, the first processor 23 determines that the device 10 is moving toward the display unit 21. When the first processor 23 determines that the signals are gradually becoming weaker, the first processor 23 determines that the device 10 is moving further away from the display unit 21.

The first wireless communication unit 12 communicates with the second wireless communication unit 24.

In a first embodiment, the second processor 14 transmits the sensed acceleration and direction of movement of the operation device 10 to the electronic device 20 through the first wireless communication unit 12 and the second wireless communication unit 24. In a second embodiment, the second processor 14 only transmits the sensed acceleration to the electronic device 20.

The first processor 23 further determines whether the status of the touched spot is unchanged within a preset period.

When the first processor 23 determines that the output of the infrared receiver 22 which generated the signal has not changed substantially within the preset period, the first processor 23 determines that the touched spot is still the focus of a user's intention. The first processor 23 further determines whether the acceleration sensed within the preset period is greater or smaller than a preset value. If equal or smaller, the first processor 23 determines that the operation device 10 has not moved. If greater, the first processor 23 determines that the operation device 10 has moved, and seeks data as to the direction of movement of the operation device 10 from the motion sensor 13, or determines the direction of movement of the operation device 10 according to variations in the strength of the signals from the infrared receiver 22 corresponding to the touched point or points. When the operation device 10 is simply moved towards the display unit 21 within the preset period, the first processor 23 controls the electronic device 20 to execute a function, such as for example, a left click operation. When the operation device 10 within the preset period is first moved toward the display unit 21, then away, and then toward the display unit 21 again, the first processor 23 controls the electronic device 20 to execute a function, such as for example, a double-click operation.

When the first processor 23 determines that the infrared receiver 22 which generated the signal changes within the preset period, the first processor 23 determines that the touched spot has changed, and then the first processor 23 tracks the touched spots (a touch track) according to the sequence of signals from the infrared receivers 22.

In the embodiment, when the touch track is not in the shape of an arc, the first processor 23 determines whether a previous function executed by the electronic device 20 corresponds to a left click operation. If yes, the first processor 23 controls the electronic device 20 to execute a further alternative function, such as for example, a drag operation. If no, the first processor 23 controls the electronic device 20 to execute a different function, such as for example, moving a cursor.

In the embodiment, when the touch track is in the shape of an arc, the first processor 23 controls the electronic device 20 to execute a function, such as for example, a right click operation. In an alternative embodiment, when the touch track is an arc from left to right, the first processor 23 controls the electronic device 20 to execute a function, such as for example, zoom in. When the arc is from right to left, the first processor 23 controls the electronic device 20 to execute a function, such as for example, zoom out.

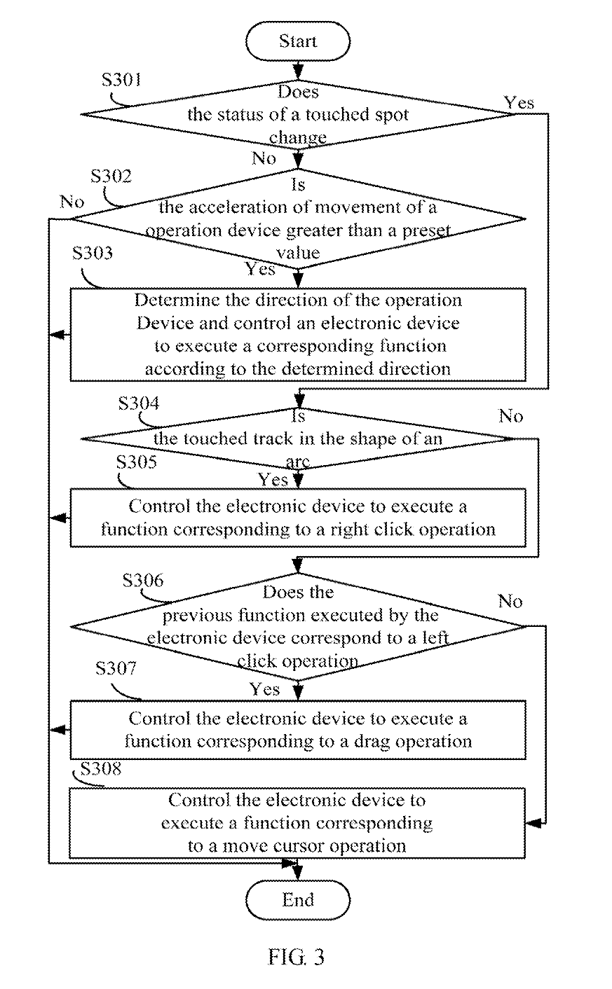

Referring to FIG. 3, a flowchart of an operation control method in accordance with an exemplary embodiment is shown. The operation control method is applied to the operation control system 1 as shown in FIGS. 1-2.

In step S301, the first processor 23 determines whether the infrared receiver 22 which generated the signal changes within a preset period to determine whether the status of the touched spot changes within a preset period. When the touched spot is unchanged within the preset period, the procedure goes to step S302. When the touched spot changes in the preset period, the procedure goes to step S304.

In step S302, the first processor 23 receives data as to acceleration of the movement detected by the motion sensor 13, and determines whether the acceleration of the movement is greater than a preset value. If yes, the procedure goes to step S303. If not, the procedure ends at step S302.

In step S303, the first processor 23 obtains the direction of movement within the preset period from the motion sensor 13 or determines the direction of movement within the preset period according to variations in the strength of the signals from the infrared receiver 22 corresponding to the touched spot, and controls the electronic device 20 to execute the corresponding function according to the determined direction of movement. In the embodiment, when the operation device 10 within a preset period simply moves toward the display unit 21, the first processor 23 controls the electronic device 20 to execute a function, such as for example, a left click operation. When the operation device 10 within a preset period is toward the display unit 21, away from the display unit 21, and then toward the display unit 21 again, the first processor 23 controls the electronic device 20 to execute a function, such as for example, to a double-click operation.

In step S304, the first processor 23 determines whether the touched track within a preset period is in the shape of an arc. If yes, the procedure goes to step S305. If no, the procedure goes to step S306.

In step S305, the first processor 23 controls the electronic device 20 to execute a function, such as for example, a right click operation.

In step S306, the first processor 23 determines whether the previous function executed by the electronic device 20 corresponds to a left click operation. If yes, the procedure goes to step S307. If no, the procedure goes to step S308.

In step S307, the first processor 23 controls the electronic device 20 to execute a function, such as for example, a drag operation.

In step S308, the first processor 23 controls the electronic device 20 to execute a function, such as for example, moving a cursor operation.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An operation control system comprising:
an operation device comprising an infrared emitter to emit infrared rays; and
an electronic device comprising:
a display unit;
a plurality of infrared receivers arranged on the display unit to receive the infrared rays emitted by the infrared emitter, each of the infrared receivers to receive a corresponding one of the infrared rays forming a light spot and further generate corresponding signals; and
a first processor electrically connected to the infrared receivers to receive the signals generated by the infrared receivers, to determine the location of one of the infrared receivers which generated the signals to determine the light spot energized by the infrared ray corresponding to the one of the infrared receivers, and control the electronic device to execute a function based on signals from the light spot and a subsequent light spot energized by the infrared rays.

2. The operation control system as described in claim 1, wherein when the status of the light spot energized by the infrared ray is unchanged within a preset period, the first processor determines the direction of movement of the operation device according to variations in the strength of the signals from the infrared receiver, when the operation device within a preset period is determined to simply move toward the display unit, the first processor controls the electronic device to execute a function corresponding to a left click operation.

3. The operation control system as described in claim 1, wherein when the status of the light spot energized by the infrared ray is unchanged within a preset period, the first processor determines the direction of movement of the operation device according to variations in the strength of the signals generated by the infrared receiver, when the operation device within a preset period is determined to move toward the display unit, away from the display unit, and then toward the display unit again, the first processor controls the electronic device to execute a function corresponding to a double-click operation.

4. The operation control system as described in claim 1, further comprising a motion sensor and a second processor, wherein the motion sensor is to detect the direction of movement of the operation device, the second processor is to transmit the direction of movement to the electronic device, when the status of the light spot energized by the infrared ray is unchanged within a preset period, the first processor obtains the direction of movement of the operation device detected by the motion sensor, when the operation device within a preset period is determined to simply move toward the display unit, the first processor controls the electronic device to execute a function corresponding to a left click operation.

5. The operation control system as described in claim 1, further comprising a motion sensor to detect the direction of movement of the operation device, wherein when the status of the light spot energized by the infrared ray is unchanged within a preset period, the first processor determines the movement direction of the operation device according to motion sensor, when the operation device within a preset period is determined to move toward the display unit, away from the display unit, and again toward the display unit, the first processor controls the electronic device to execute a function corresponding to a double-click operation.

6. The operation control system as described in claim 2, wherein when the status of the light spot energized by the infrared ray changes within a preset period, the touched track is not in the shape of an arc within a preset period, and the previous function executed by the electronic device corresponds to a left click operation, the first processor controls the electronic device to execute a function corresponding to a drag operation.

7. The operation control system as described in claim 4, wherein when the status of the light spot energized by the infrared ray changes within a preset period, the touched track is not in the shape of an arc within a preset period, and the previous function executed by the electronic device corresponds to a left click operation, the first processor controls the electronic device to execute a function corresponding to a drag operation.

8. The operation control system as described in claim 2, wherein when the status of the light spot energized by the infrared ray changes within a preset period, the touched track is not in the shape of an arc within a preset period, and the previous function executed by the electronic device does not correspond to a left click operation, the first processor controls the electronic device to execute a function corresponding to a moving cursor operation.

9. The operation control system as described in claim 4, wherein when the status of the light spot energized by the infrared ray changes within a preset period, the touched track is not in the shape of an arc within a preset period, and the previous function executed by the electronic device does not correspond to a left click operation, the first processor controls the electronic device to execute a function corresponding to moving a cursor operation.

10. The operation control system as described in claim 1, wherein when the status of the light spot energized by the infrared ray changes within a preset period, the touched track is in the shape of an arc within a preset period, the first processor controls the electronic device to execute a function corresponding to a right click operation.

11. An operation control method, the method being applied on an operation control system, the system comprising an operation device and an electronic device, the operation device comprising an infrared emitter to emit infrared rays; the electronic device comprising a display unit and a plurality of infrared receivers, the infrared receivers being arranged on the display unit, each of the infrared receivers being to receive the infrared rays emitted by the infrared emitter, each of the infrared receivers to receive a corresponding one of the infrared rays forming a light spot and generate corresponding signals, wherein the method comprises:
receiving the signals generated by the infrared receivers, determining the location of one of the infrared receivers which generated the signals to determine the light spot energized by the infrared ray corresponding to the one of the infrared receivers, and controlling the electronic device to execute a function based on signals from the light spot and a subsequent light spot energized by the infrared rays.

12. The operation control method as described in claim 11, wherein the method further comprises:
determining the direction of movement of the operation device according to the variant in the strength of the signals from the infrared receiver, when status of the light spot energized by the infrared ray is unchanged within a preset period; and
controlling the electronic device to execute a function corresponding to a left click operation, when the operation device is determined to simply move toward the display unit.

13. The operation control method as described in claim 11, wherein the method further comprises:
determining the direction of movement of the operation device according to the variant in the strength of the signals from the infrared receiver, when the status of the light spot energized by the infrared ray is unchanged within a preset period; and
controlling the electronic device to execute a function corresponding to a double-click operation, when the operation device is determined within a preset period to move toward the display unit, away from the display unit, and again toward the display unit.

14. The operation control method as described in claim 11, the operation device further comprising a motion sensor, wherein the method further comprises:
determining the direction of movement of the operation device according to the motion sensor, when the status of the light spot energized by the infrared ray is unchanged within a preset period; and
controlling the electronic device to execute a function corresponding to a left click operation, when the operation device is determined to simply move toward the display unit within a preset period.

15. The operation control method as described in claim 11, the operation device further comprising a motion sensor, wherein the method further comprises:
determining the direction of movement of the operation device according to the motion sensor, when the status of the light spot energized by the infrared ray is unchanged within a preset period; and
controlling the electronic device to execute a function corresponding to a double-click operation, when the operation device within a preset period is determined to move toward the display unit, away from the display unit, and again toward the display unit.

16. The operation control method as described in claim 12, wherein the method further comprises:
controlling the electronic device to execute a function corresponding to a drag operation, when the status of the light spot energized by the infrared ray changes within a preset period, the touched track is not in the shape of an arc within a preset period, and the previous function executed by the electronic device corresponds to a left click operation.

17. The operation control method as described in claim 12, wherein the method further comprises:
controlling the electronic device to execute a function corresponding to a moving cursor operation, when the status of the light spot energized by the infrared ray changes within a preset period, the touched track is not in the shape of an arc within a preset period, and the previous function executed by the electronic device does not correspond to a left click operation.

18. The operation control method as described in claim 14, wherein the method further comprises:
controlling the electronic device to execute a function corresponding to a drag operation, when the status of the light spot energized by the infrared ray changes within a preset period, the touched track is not in the shape of an arc within a preset period, and the previous function executed by the electronic device corresponds to a left click operation.

19. The operation control method as described in claim 14, wherein the method further comprises:
controlling the electronic device to execute a function corresponding to a moving cursor operation, when the status of the light spot energized by the infrared ray changes within a preset period, the touched track is not in the shape of an arc within a preset period, and the previous function executed by the electronic device does not correspond to a left click operation.

20. The operation control method as described in claim 11, further comprising:
controlling the electronic device to execute a function corresponding to a right click operation when the status of the light spot energized by the infrared ray changes within a preset period and the touched track is in the shape of an arc within a preset period.
